(19) United States
(12) Patent Application Publication
(10) Pub. No.: US 2012/0256828 A1
(43) Pub. Date: Oct. 11, 2012

(54) CURSOR CONTROL DEVICE

(75) Inventors: TAI-CHUN LI, Shenzhen (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/097,092

(22) Filed: Apr. 29, 2011

(30) Foreign Application Priority Data
Apr. 8, 2011 (CN) 201110087968.9

(51) Int. Cl. G06F 3/033

(52) U.S. Cl. 345/157

(57) ABSTRACT

The cursor control device includes a housing, a first capacitor, a second capacitor, a first capacitance measurement unit, a second capacitance measurement unit, and a processor. Each capacitor includes a stator plate and a rotor plate. The rotor plates are movable relative to the stator plates. The stator plate and the rotor plate of the first capacitor are substantially perpendicular to the stator plate and the rotor plate of the second capacitor. The capacitance measurement units respectively measure the corresponding capacitance of the capacitors. The processor analyzes acceleration and duration of the changes in capacitance to ascertain movement direction and distance of the device according to the capacitance measured by the capacitance measurement units, when the capacitance between the stator plate and the rotor plate of the first capacitor, or between the stator plate and the rotor plate of the second capacitor changes.

### BACKGROUND

1. Technical Field

The present disclosure relates to cursor control devices.

2. Description of Related Art

As one of the main input devices for a computer, computer mice have become an inseparable part of desktop computer systems. The conventional mice must depend on the supporting surface of a desk, thus it is not convenient. Although 3D mice are independent of the supporting surface of the desk, they are expensive.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view showing an interior structure of a cursor control device in accordance with an exemplary embodiment.

FIG. 2 is a block diagram of the cursor control device of FIG. 1 in accordance with an exemplary embodiment.

### DETAILED DESCRIPTION

Embodiments of the present disclosure are now described in detail, with reference to the accompanying drawings.

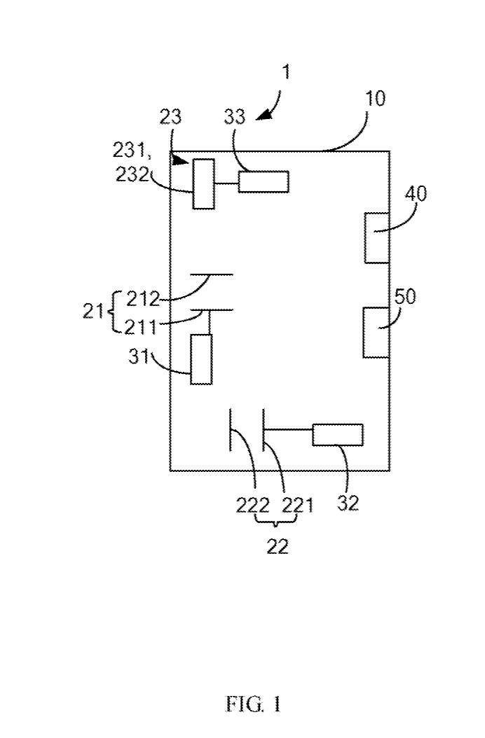

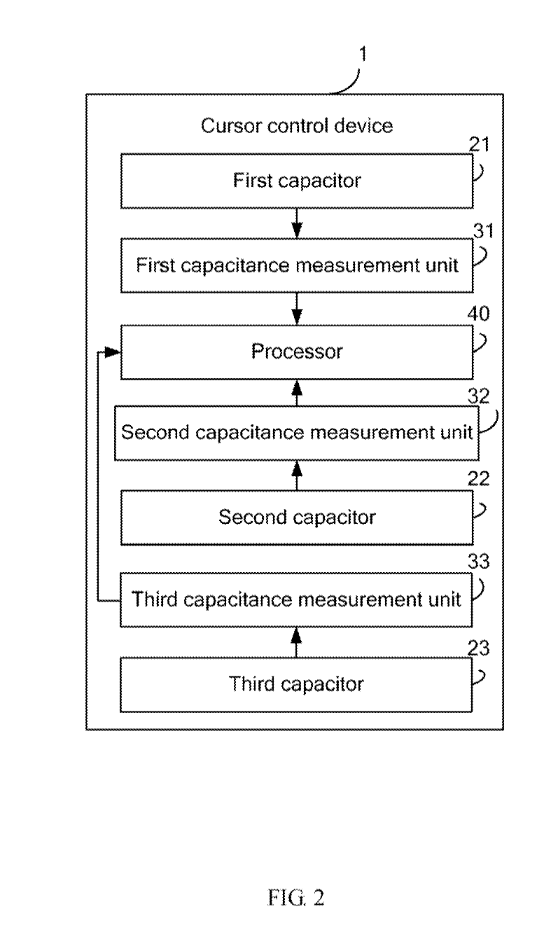

Referring to FIGS. 1-2, in the embodiments, a cursor control device 1 includes a first capacitor 21, a second capacitor 22, a first capacitance measurement unit 31, a second capacitance measurement unit 32, and a processor 40 all arranged in a housing 10.

The capacitors 21, 22 are variable capacitors. The first capacitor 21 includes a first stator plate 211 and a first rotor plate 212 parallel to each other. The second capacitor 22 includes a second stator plate 221 and a second rotor plate 222 parallel to each other. The stator plates 211, 221 and the rotor plates 212, 222 are made of conductive material. The first stator plate 211 and the first rotor plate 212 of the first capacitor 21 are substantially perpendicular to the second stator plate 221 and the second rotor plate 221 of the second capacitor 22 in the housing 10. The rotor plates 212, 222 are movable relative to the stator plates 211, 221 within the capacitors 21, 22. The first capacitance measurement unit 31 is electrically connected to the first capacitor 21 to measure the capacitance of the first capacitor 21. The second capacitance measurement unit 32 is electrically connected to the second capacitor 22 to measure the capacitance of the second capacitor 22.

Whenever the device 1 is moved, inertia acts on the rotor plates 212, 222 and changes the distance, and therefore the capacitance, between the rotor plates 212, 222 and the stator plates 211, 221 changes. The changes in capacitance are measured by the measurement units 31, 32 and sent to the processor 40. The processor 40 further analyzes acceleration and duration of the changes in capacitance to obtain X and Y vectors which can then be added to ascertain movement direction and distance of the device 1 according to the capacitance measured by the measurement units 31, 32.

The detail process of ascertaining movement direction and distance of the device 1 according to the capacitance measured by the measurement units 31, 32 is described below.

The processor 40 obtains the capacitance measured by the measurement units 31, 32, and ascertains the movement direction of the rotor plates 212, 222 according to the formula C=εs/4πkd. Wherein c is the capacitance of the capacitors 21 or 22, c is the dielectric constant of the dielectric between the first stator plate 211 and the first rotor plate 212 or between the second stator plate 221 and the second rotor plate 222, s is the effective area between the first stator plate 211 and the first rotor plate 212 or between the second stator plate 221 and the second rotor plate 222, and d is the vertical distance between the first stator plate 211 and the first rotor plate 212 or between the second stator plate 221 and the second rotor plate 222. For the inertia, the movement direction of the rotor plates 212, 222 is opposite to the movement direction of the device 1. The movement direction of the first rotor plate 212 corresponds to the Y vector of the device 1, and the movement direction of the second rotor plate 222 corresponds to the X vector of the device 1. The processor 40 further determines the movement distance of the device 1 on the X and Y vectors to add to ascertain movement direction and distance of the device 1.

In the embodiment, the device 1 further includes a wireless communication unit 50 to communicate with a computer. The processor 40 sends a control signal to the computer through the wireless communication unit 50 according to the added movement direction and the distance of the device 1. In another embodiment, the device 1 communicates over cable with a computer.

In another embodiment, the device 1 further includes a third capacitor 23 and a third capacitance measurement unit 33. The third capacitor 23 includes a third stator plate 231 and a third rotor plate 232. The third capacitance measurement unit 33 is electrically connected to the third capacitor 23 to measure the capacitance of the third capacitor 23. The third stator plate 231 and the third rotor plate 232 of the third capacitor 23 are substantial perpendicular to the first stator plate 211 and the first rotor plate 212 of the first capacitor 21 and the second stator plate 221 and the second rotor plate 222 of the second capacitor 22. The movement direction of the third rotor plate 232 corresponds to the Z vector of the device 1. When the capacitance between the rotor plates 212, 222, 232 and the stator plates 211, 221, 231 changes, the processor 40 further analyzes acceleration and duration of the changes in capacitance to obtain X, Y, and Z vectors which can then be added to ascertain movement direction and distance of the device 1 according to the capacitance measured by the measurement units 31, 32, 33.

In this way, the device 1 can be held on the hand to operate in the three dimensions, do not need any supporting surface to operate. Furthermore, the device 1 can be used as a video game console for the user to play game.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A cursor control device comprising:
a housing;
a first capacitor comprising a first stator plate and a first rotor plate, the first stator plate being movable relative to the first rotor plate;
a second capacitor comprising a second stator plate and a second rotor plate, the second stator plate being movable relative to the second rotor plate, the second stator plate and the second rotor plate of the second capacitor being substantially perpendicular to the first stator plate and the first rotor plate of the first capacitor;
a first capacitance measurement unit electrically connected to the first capacitor to measure the capacitance of the first capacitor;
a second capacitance measurement unit electrically connected to the second capacitor to measure the capacitance of the second capacitor; and
a processor to analyze acceleration and duration of the changes in capacitance to ascertain movement direction and distance of the cursor control device according to the capacitance measured by the first capacitance measurement unit and the second capacitance measurement unit, when the capacitance between the first stator plate of the first capacitor and the first rotor plate of the first capacitor or between the second stator plate of the second capacitor and the second rotor plates of the second capacitor changes.

2. The cursor control device as described in claim 1, further comprising a wireless communication unit, through which the cursor control device communicating with a computer.

3. The cursor control device as described in claim 1, wherein the cursor control device communicates over cable with a computer.

4. The cursor control device as described in claim 1, wherein the first stator plate, the first rotor plate, the second stator plate and the second rotor plate are made of conductive material.

5. The cursor control device as described in claim 1, further comprising a third capacitor and a third capacitance measurement unit to measure the capacitance of the third capacitor, the third capacitor comprising a third stator plate and a third rotor plate, wherein the processor analyzes acceleration and duration of the changes in capacitance to ascertain movement direction and distance of the device according to the capacitance measured by the first capacitance measurement unit, the second capacitance measurement unit, and the third capacitance measurement unit, when the capacitance between the first stator plate and the first rotor plate of the first capacitor, or between the second stator plate and the second rotor plate of the second capacitor, or between the third stator plate and the third rotor plate of the third capacitor changes.
